(19) United States
(12) Patent Application Publication
(10) Pub. No.: US 2007/0211038 A1
(43) Pub. Date: Sep. 13, 2007

(54) Multifunction touchpad for a computer system

(75) Inventors: Chu-Chia Tsai, Taipei Hsien (TW); Hung-Liang Hsu, Taipei Hsien (TW)

Correspondence Address: BACON & THOMAS, PLLC, 625 SLATERS LANE, FOURTH FLOOR, ALEXANDRIA, VA, 22314, US

(73) Assignee: Wistron Corporation, Taipei Hsien (TW)

(21) Appl. No.: 11/515,032

(22) Filed: Sep. 5, 2006

(30) Foreign Application Priority Data
Mar. 8, 2006 (TW) 095107805

(51) Int. Cl. G06F 3/041

(52) U.S. Cl. 345/173

(57) ABSTRACT

A multifunction touchpad is placed on an operation panel of a notebook computer to control the notebook computer. The multifunction touchpad comprises a display panel, a control module, and a wireless transmission module. The multifunction touchpad can display an operation menu and a system message on the display panel by way of a software program, and can be used wirelessly when separated from the notebook computer.

### BACKGROUND OF THE INVENTION

1. Field of the Invention

The present invention relates to a multifunction touchpad, and more particularly to a multifunction touchpad capable of displaying operation menus and system messages and having wireless transmission function.

2. Description of the Related Art

In the prior art, the touchpad of the notebook computer is only used for controlling the mouse cursor; however, some application programs require more capabilities. Furthermore, while the user is using the touchpad, he or she cannot obtain instant system messages. Moreover, the prior art touchpad cannot be separated from the notebook computer, which can be very inconvenient.

Therefore, it is desirable to provide a new multifunction touchpad to solve the aforementioned problems.

### SUMMARY OF THE INVENTION

A main object of the present invention is to provide a multifunction touchpad capable of switching operation menus.

Another object of the present invention is to provide a multifunction touchpad capable of displaying system message.

Another object of the present invention is to provide a multifunction touchpad capable of wireless transmission.

In order to achieve the above-mentioned object, the multifunction touchpad of the present invention comprises a display panel, a control module and a wireless transmission module for controlling the notebook computer; and a software program can be used for setting the pictures displayed on the display panel.

An operation method for the multifunction touchpad of the present invention comprises: detecting whether the mode switch key has been pressed; and if the mode switch key has been pressed, switching to a corresponding operation mode.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a notebook computer according to the present invention.

FIG. 2 is a schematic view of a multifunction touchpad according to the present invention.

FIG. 3 shows a multifunction touchpad and a notebook computer being separated according to the present invention.

FIG. 4 shows a multifunction touchpad in a basic input operational configuration according to the present invention.

FIG. 5 shows a multifunction touchpad in a multi-media software operational configuration according to the present invention.

FIG. 6 shows a multifunction touchpad in a network phone operational configuration according to the present invention.

FIG. 7 is a flowchart for operating a multifunction touchpad according to the present invention.

### DETAILED DESCRIPTION OF THE PREFERRED EMBODIMENT

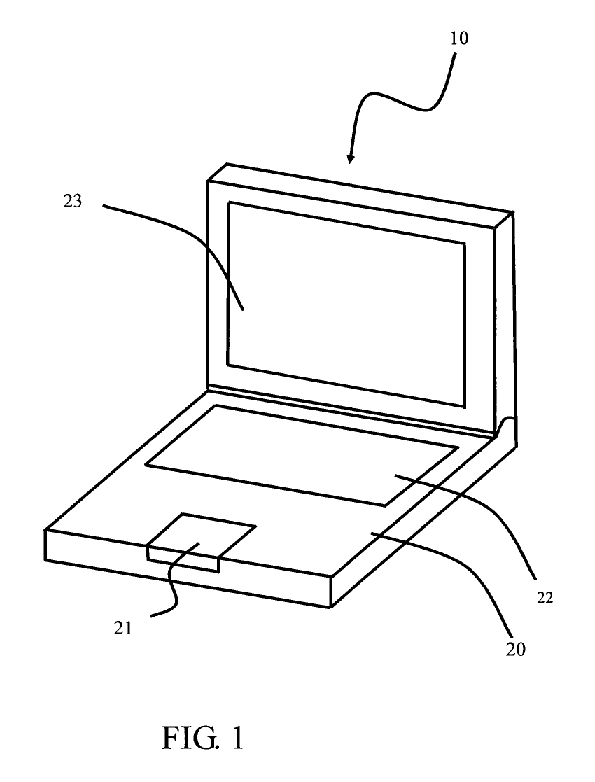

Please refer to FIG. 1. FIG. 1 is a perspective view of a notebook computer according to the present invention. As shown in FIG. 1, a notebook computer 10 has an operation panel 20 and a screen 23. The operation panel 20 comprises a keyboard area 22 and a multifunction touchpad 21. The keyboard area 22 has a plurality of keys (not shown), which are used to input texts, numbers, and commands to control the notebook computer 10. Since the keyboard area 22 is a well known technology, there is no need for further description.

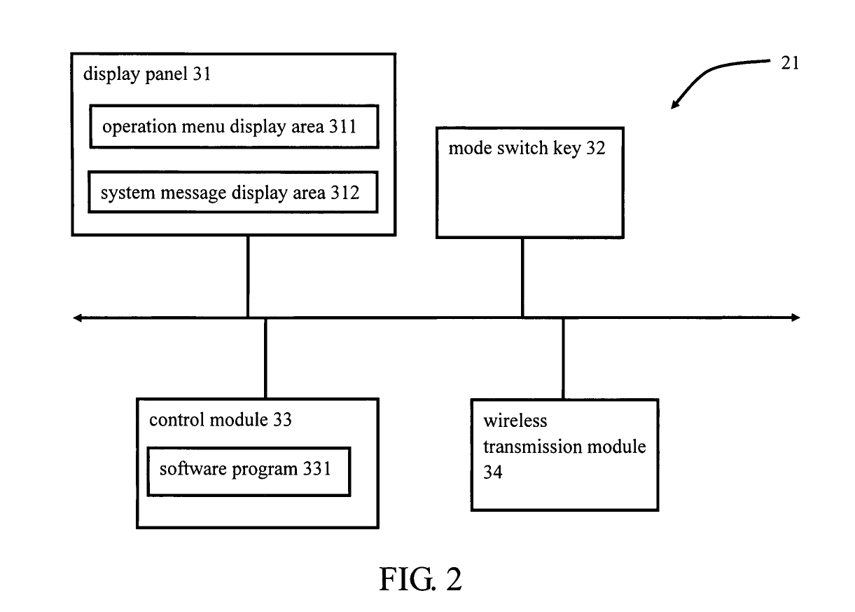

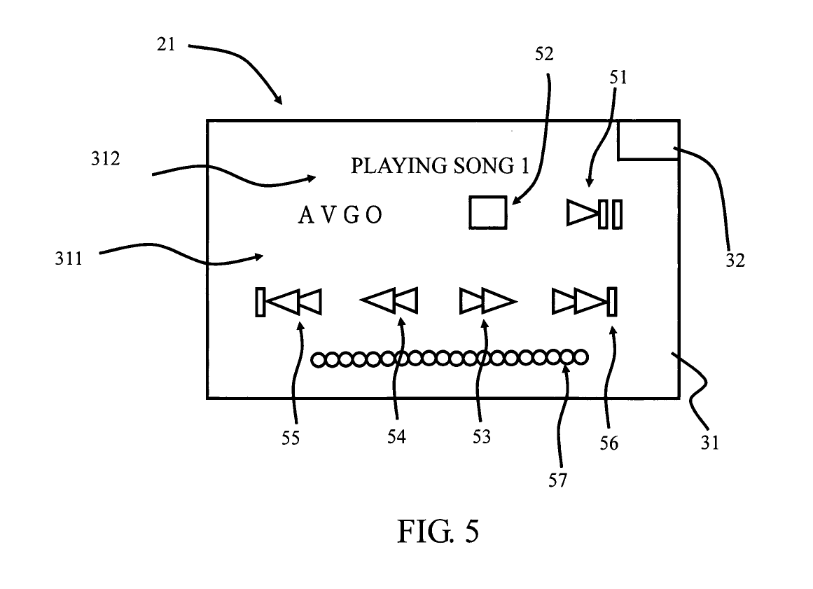

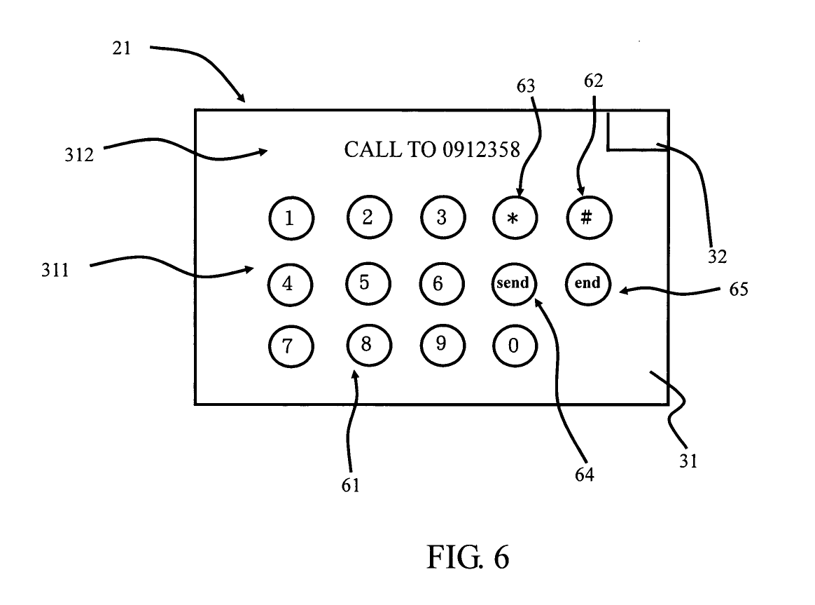

Please refer to FIG. 2. FIG. 2 is a schematic view of a multifunction touchpad according to the present invention. The multifunction touchpad 21 is a film on glass or a capacitive touch panel with a display panel 31. In this embodiment, the display panel 31 is an LCD panel, but which should not be construed as a limitation of the present invention. The display panel 31 has an operation menu display area 311 and a system message display area 312. The multifunction touchpad 21 has a control module 33 and a wireless transmission module 34. The multifunction touchpad 21 uses the software program 331 of the control module 33 to control the picture displayed on the display panel 31. The multifunction touchpad 21 further has a wireless transmission module 34, such as a transmission module with Bluetooth functionality, which should not be construed as a limitation of the present invention. Additionally, the operation menu display area 311 of the display panel 31 has virtual buttons (as shown in FIG. 5 to FIG. 6), and the multifunction touchpad 21 can be used with fingers, a touch pen or any other similar device. The multifunction touchpad 21 has a virtual mode switch key 32 for switching between different operating modes, which should not be construed as a limitation of the present invention. The mode switch key 32 and the multifunction touchpad 21 can be separated and disposed on the operation panel 20 of the notebook computer 10.

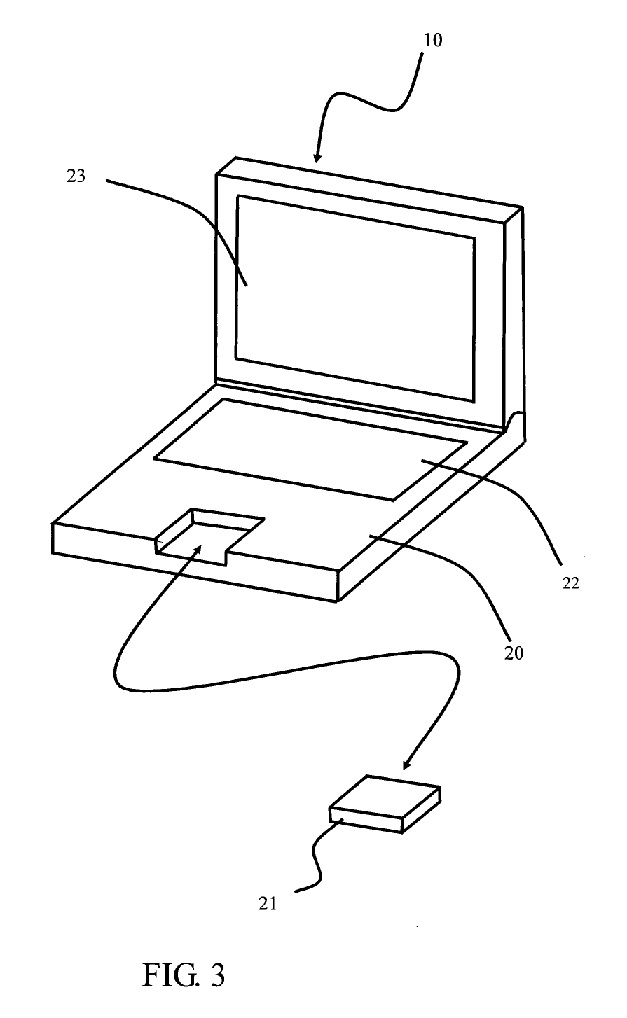

Please refer to FIG. 3. FIG. 3 shows the multifunction touchpad 21 and the notebook computer 10 being separated according to the present invention. Since the multifunction touchpad 21 further comprises a wireless transmission module 34, the multifunction touchpad 21 can continue to control the notebook computer 10 even when separated from the operation panel 20 of the notebook computer 10.

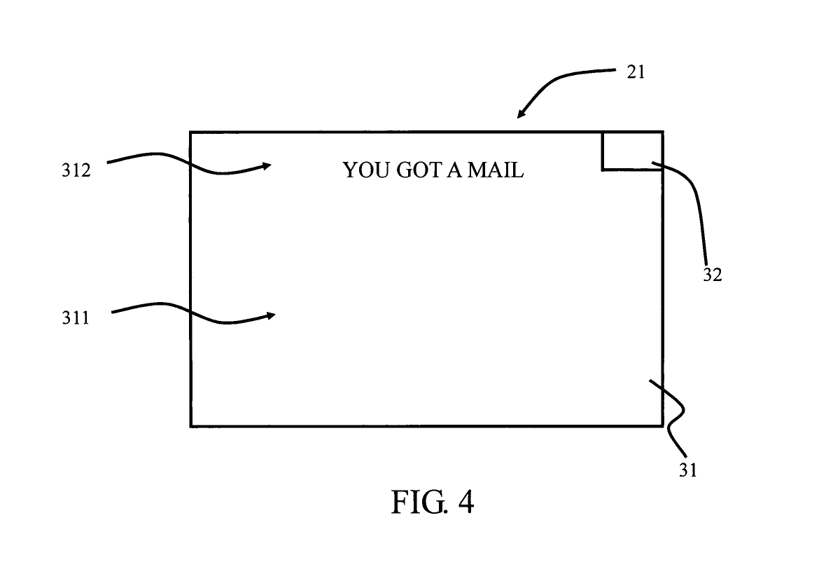

Please refer to FIG. 4 to FIG. 6. FIG. 4 shows the multifunction touchpad for use under a basic input operation configuration according to the present invention. FIG. 5 shows the multifunction touchpad for use under a multi-media software operation configuration according to the present invention. FIG. 6 shows the multifunction touchpad for use under a network phone operation configuration according to the present invention.

As shown in FIG. 4 to FIG. 6, the surface of the multifunction touchpad 21 includes the mode switch key 32 and the display panel 31. The display panel 31 can be separated into the operation menu display area 311 and the system message display area 312. In one embodiment, the software program 331 of the control module 33 may be set to display pictures or system messages in the operation menu display area 311 or the system message display area 312 (please refer to FIG. 2).

As shown in FIG. 4, when a user presses the mode switch key 32, the multifunction touchpad 21 switches into the basic input operation configuration. The system message display area 312 of the display panel 31 displays basic messages of the notebook computer 10. The basic messages can be date/time messages, mail-related messages and/or computer status messages. The date/time message may include time or date messages; the mail message informs the user when the notebook computer 10 receives a new email; the computer status message displays the system status of the notebook computer 10, such as the power status or network connection status of the notebook computer 10. Also, while under the basic input operation configuration, the operation menu display area 311 of the display panel 31 displays the basic input operation menu, which includes a mouse cursor control mode menu and/or a handwriting input mode menu.

As shown in FIG. 5, when the user presses the mode switch key 32 to switch the multifunction touchpad 21 into the multi-media software operation mode, the system message display area 312 of the display panel 31 displays multi-media software messages. The multi-media software includes software for playing video, music or MP3 files. Multi-media software messages may include title or other information, or the playing time of the played video or music. Meanwhile, when under the multi-media software operation mode, the operation menu display area 311 of the display panel 31 displays the multi-media software operation menu, which includes a play/pause key 51, a stop key 52, a fast forward key 53, a rewind key 54, a previous key 55 and a next key 56, etc. The user may use these virtual keys on the operation menu display area 311 to control the multi-media software. Furthermore, in one embodiment, a time frame 57 is also displayed on the operation menu display area 311, which can display the playing time and a total time frame of played video or music. The time frame 57 can be also used to choose a desired video or music section by users. Moreover, the operation menu display area 311 also includes a virtual volume control key (not shown), and the user can control the volume by moving his or her finger along the virtual volume control key.

As shown in FIG. 6, when the user presses the mode switch key 32 to switch the multifunction touchpad 21 into the network phone operation mode, the operation menu display area 311 of the display panel 31 displays number keys 61, a key #62, a key* 63, a dial key 64, an end key 65, etc. as virtual keys. The user can use the virtual keys displayed on the operation menu display area 311 to input numbers or symbols to dial or receive a networked phone call. Under the network phone operation mode, the system message display area 312 of the display panel 31 displays the dialed or received phone number. Similarly, the operation menu display area 311 may also have a volume key (not shown), which the user can use to control the volume by moving his or her finger along the virtual volume control key.

However, the operation mode of the multifunction touchpad 21 can provide more than the above-mentioned three operation mode configurations; the software program 331 can be used for adding other operation modes. The software program 331 can also be used to configure an operation mode for the multifunction touchpad 21 when the notebook computer 10 is switched into the operation mode for a corresponding piece of software (such as the multiple media software operation mode); or to enable a corresponding operation mode of the notebook computer 10 when the multifunction touchpad 21 is switched into the operation mode for a certain piece of software (such as the multiple media software operation mode).

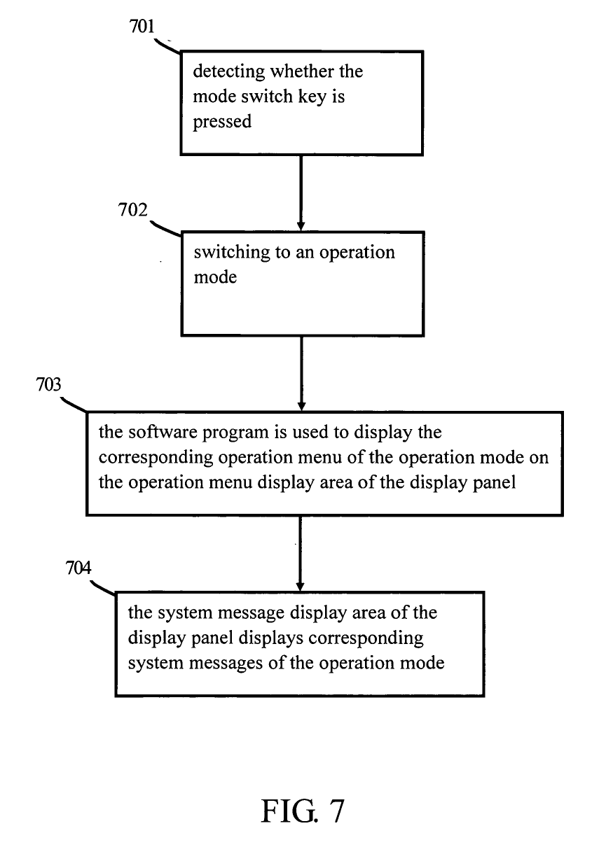

Please refer to FIG. 7. FIG. 7 is a flowchart for operating the multifunction touchpad 21 according to the present invention. As shown in FIG. 7, the method of the present invention comprises the following steps:

Step 701: detecting whether the mode switch key 32 is pressed. The user can press the mode switch key 32 of the multifunction touchpad 21 to switch between different operation modes, and so step 701 is used for detecting whether the mode switch key 32 has been pressed.

Next, when the mode switch key 32 is detected as being pressed, in step 702: switching to an operation mode. In one embodiment, if the user presses the mode switch key 32 several times, the multifunction touchpad 21 can be switched between several available operate modes.

When the corresponding operation mode is enabled, the present invention proceeds with step 703: the software program 331 is used to display the corresponding operation menu of the operation mode on the operation menu display area 311 of the display panel 31.

In the meanwhile the present invention proceeds with step 704: the system message display area 312 of the display panel 31 displays corresponding system messages of the operation mode.

The switching sequence of the operation modes of the multifunction touchpad 21 is not limited to particular configurations, and may be changed by the software program 331.

Although the present invention has been explained in relation to its preferred embodiment, it is to be understood that many other possible modifications and variations can be made without departing from the spirit and scope of the invention as hereinafter claimed.

What is claimed is:

1. A notebook computer comprising a screen and an operation panel, the operation panel comprising:
a keyboard area for inputting texts, numbers or commands to control the notebook computer; and
a multifunction touchpad comprising:
a display panel for displaying at least one operation menu or at least one system message to control the notebook computer; and
a control module comprising a software program for controlling the at least one operation menu or the at least one system message displayed by the display panel.

2. The notebook computer as claimed in claim 1, wherein the display panel is an LCD panel.

3. The notebook computer as claimed in claim 1 further comprising a mode switch key for switching the at least one operation menu.

4. The notebook computer as claimed in claim 1 further comprising a wireless transmission module to enable the multifunction touchpad to control the notebook computer when separated from the notebook computer.

5. The notebook computer as claimed in claim 1, wherein the at least one operation menu comprises a basic input operation menu, a multi-media software operation menu or a network phone operation menu.

6. The notebook computer as claimed in claim 5, wherein the basic input operation menu comprises a mouse cursor control mode menu or a hand-writing input mode menu.

7. The notebook computer as claimed in claim 1, wherein the at least one system message comprises a basic message, a multi-media software message and a network phone message.

8. The notebook computer as claimed in claim 7, wherein the basic message comprises a time message, a mail message or a computer status message.

9. A multifunction touchpad for a notebook computer, the notebook computer comprising a screen and a keyboard area, the multifunction touchpad disposed near the keyboard area, the multifunction touchpad comprising:
a display panel for displaying at least one operation menu or at least one system message for controlling the notebook computer; and
a control module for controlling the at least one operation menu or the at least one system message displayed on the display panel.

10. The multifunction touchpad as claimed in claim 9, wherein the display panel is an LCD panel.

11. The multifunction touchpad as claimed in claim 9, wherein the control module comprises a software program.

12. The multifunction touchpad as claimed in claim 9 further comprising a mode switch key for switching the at least one operation menu.

13. The multifunction touchpad as claimed in claim 9 further comprising a wireless transmission module to enable the multifunction touchpad to control the notebook computer while separated from the notebook computer.

14. The multifunction touchpad as claimed in claim 9, wherein the at least one operation menu comprises a basic input operation menu, which comprises a mouse cursor control mode menu or a hand-writing input mode menu.

15. The multifunction touchpad as claimed in claim 9, wherein the at least one operation menu comprises a multi-media software operation menu.

16. The multifunction touchpad as claimed in claim 9, wherein the at least one operation menu comprises a network phone operation menu.

17. The multifunction touchpad as claimed in claim 9, wherein the at least one system message comprises a basic message which comprises a time message, a mail message or a computer status message.

18. The multifunction touchpad as claimed in claim 9, wherein the at least one system message comprises a multi-media software message.

19. The multifunction touchpad as claimed in claim 9, wherein the at least one system message comprises a network phone message.

20. A method of controlling a multifunction touchpad on a notebook computer, the multifunction touchpad comprising a display panel, the display panel displaying at least one system message or at least one operation menu; the method comprising:
switching to an operation mode; and
displaying the operation menu or the system message corresponding to the operation mode of the display panel.

21. The method as claimed in claim 20, wherein the multifunction touchpad further comprises a mode switch key, the method further comprising:
detecting whether the mode switch key has been pressed; and
if the mode switch key has been pressed, switching to a corresponding operation mode.

22. The method as claimed in claim 20, wherein the multifunction touchpad further comprises a wireless transmission module, the method further comprising:
using the wireless transmission module to transmit an operation command to switch the operation mode.

23. The method as claimed in claim 20, wherein the notebook computer further comprises a software program, the method further comprising:
when switching to the operation mode of the multifunction touchpad, using the software program to enable the operation mode of a corresponding piece of software in the notebook computer; or
when switching to the operation mode of the software program in the notebook computer, using the software program to enable the corresponding operation mode of the multifunction touchpad.

24. The method as claimed in claim 20, wherein the step of switching the operation mode further comprises:
switching to a basic input operation mode, the basic input operation mode comprising a mouse cursor control mode or a hand-writing input mode;
switching to a multi-media software operation mode; or
switching to a network phone operation mode.

25. The method as claimed in claim 20, wherein the step of displaying the system message further comprises:
displaying a basic message which comprises a time message, a mail message or a computer status message;
displaying a multi-media software message; or
displaying a network phone message.
